(19) United States
(12) Patent Application Publication
(10) Pub. No.: US 2026/0116313 A1
(43) Pub. Date: Apr. 30, 2026

(54) VEHICLE CONSOLE HAVING HIDDEN COMPARTMENT WITH RF BLOCKER

(71) Applicant: Ford Global Technologies, LLC, Dearborn, MI (US)

(72) Inventors: Karim Habib Abraham Lopez, Tlalnepantla (MX); Karla Guemes, Mexico City (MX); Grecia Indira De Leon Gonzalez, Mexico City (MX); Abraham Vidal, Puebla (MX)

(73) Assignee: Ford Global Technologies, LLC, Dearborn, MI (US)

(21) Appl. No.: 18/932,787

(22) Filed: Oct. 31, 2024

(51) Int. Cl. B60R 11/02; B60R 11/00

(52) U.S. Cl. CPC B60R 11/0241; B60R 11/0252; B60R 2011/0007

(57) ABSTRACT

A vehicle console has a housing with an upper storage compartment, a top access opening, and a hidden lower storage compartment. An upper panel defines a bottom floor of the upper storage compartment. A lower floor is located below the upper panel. A hidden lower extends storage compartment between the upper panel and the lower floor. A radio frequency blocker is provided in the upper panel to block the transmission of radio frequency signals through the upper panel.

### FIELD OF THE DISCLOSURE

The present disclosure generally relates to console arrangements for motor vehicles, and more particularly relates to a vehicle console having a hidden compartment that blocks radio frequency (RF) signals.

### BACKGROUND OF THE DISCLOSURE

Motor vehicles are commonly equipped with storage compartments, such as consoles. For example, a center console is often installed between a driver's seat and a passenger's front seat in a front row of seating in a passenger motor vehicle. The center console typically has a main storage compartment configured to hold one or more cargo items within the main storage compartment. It would be desirable to provide for a console on a vehicle for cargo that offers hidden storage and blocks the transmission of radio frequency signals.

### SUMMARY OF THE DISCLOSURE

According to a first aspect of the present disclosure, a vehicle console has a housing with an upper storage compartment, a top access opening, and a hidden lower storage compartment. An upper panel defines a bottom floor of the upper storage compartment. A lower floor is located below the upper panel. A hidden lower extends storage compartment between the upper panel and the lower floor. A radio frequency blocker is provided in the upper panel to block the transmission of radio frequency signals through the upper panel.

Embodiments of the first aspect of the present disclosure can include any one or a combination of the following features:
a lid coupled to the housing and moveable between an open position exposing the top access opening and a closed position covering the top access opening;
the upper panel is movable to an open position to allow access to the hidden lower storage compartment;
the upper panel is coupled to the housing via one or more hinges;
the radio frequency blocker comprises an electrically conductive material;
the electrically conductive material is provided in the upper panel;
the electrically conductive material is further provided in lower sidewalls of the housing defining the hidden lower storage compartment;
the electrically conductive material forms an electrically conductive signal shield;
the electrically conductive material comprises aluminum foil;
the upper panel is configured to rest on a frame base which rests on a rim on the lower sidewalls; and
the console is a center console configured to be positioned between first and second seats in a vehicle.

According to a second aspect of the present disclosure, a vehicle center console has a housing with an upper storage compartment, a top access opening, and a hidden lower storage compartment. An upper panel is proximate to a bottom of the upper storage compartment and moveable to an open position to access the hidden lower storage compartment. A lower floor is located below the upper panel. The hidden lower storage compartment extends between the upper panel and the lower floor. A lid is coupled to the housing and moveable between an open position exposing the top access opening and a closed position covering the top access opening. A radio frequency blocker is provided in the upper panel to block the transmission of radio frequency signals through the upper panel.

Embodiments of the second aspect of the present disclosure can include any one or a combination of the following features:
the upper panel is movable by pivoting to an open position to allow access to the hidden lower storage compartment;
the upper panel is coupled to the housing via one or more hinges;
the radio frequency blocker comprises an electrically conductive material;
the electrically conductive material is provided in the upper panel;
the electrically conductive material is provided in lower sidewalls of the housing defining the hidden lower storage compartment;
the electrically conductive material forms an electrically conductive signal shield;
the upper panel is configured to rest on a frame base which rests on a rim on the lower sidewalls; and
the electrically conductive material comprises aluminum foil.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper side perspective view of a cabin interior of a motor vehicle equipped with a center console having a false floor hidden compartment configured to block RF signals, according to one embodiment;

FIG. 2 is an upper side perspective view of the center console with the lid in the closed position;

FIG. 3 is an upper side perspective view of the center console with the lid in the open position;

FIG. 4 is an upper side perspective view of the center console with the lid in the open position and an upper false floor pivoted to an open position to expose a hidden compartment;

FIG. 5 is a cross-sectional view taken through line V-V of FIG. 2;

FIG. 5A is an enlarged view of section VA in FIG. 5; and

FIG. 6 is an exploded upper perspective view of the center console.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

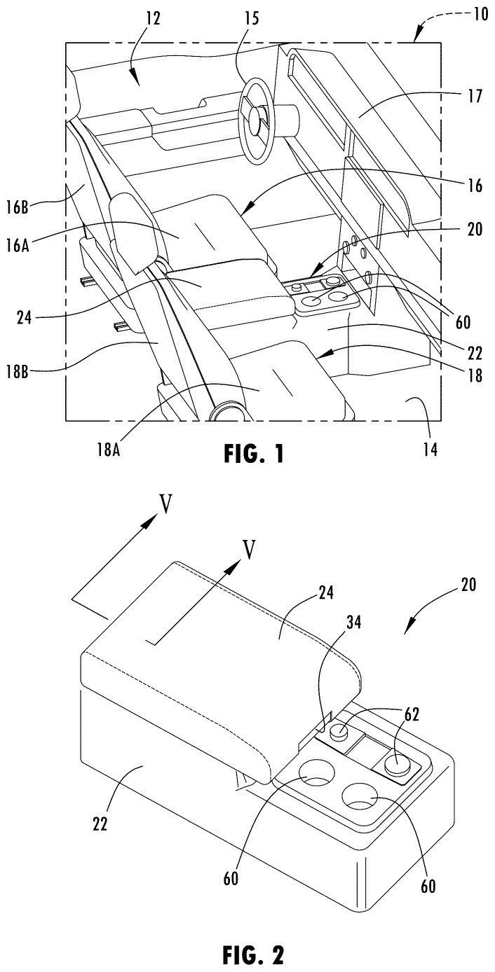

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle console. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring particularly to FIG. 1, a motor vehicle 10, such as a wheeled motor vehicle, is generally illustrated configured with passenger seating for transporting one or more passengers including a driver of the motor vehicle 10 and further configured for transporting one or more cargo items onboard the motor vehicle 10. The motor vehicle 10 has a vehicle body that generally defines a cabin interior 12. The cabin interior 12 may contain various features and trim components. The cabin interior 12 is shown having an arrangement of front row of passenger seats including a first seat assembly 16 configured to seat a driver of the motor vehicle 10 and a second seat assembly 18 configured to seat a passenger. The first and second seat assemblies 16 and 18 may be configured as Captain seats, for example, laterally spaced apart and separated by a space that is substantially consumed by a front row center console 20 that may be configured with a hidden storage compartment that is configured to block the transmission of RF signals, according to one embodiment as shown and described herein.

The motor vehicle 10 may include additional seating such as a second row of seating which may include third and fourth seat assemblies, for example, that may be spaced apart and may be separated by a second row center console that could be configured according to the embodiment shown and described herein. The motor vehicle 10 may include additional rows of seating such as a third row of seating for extended vehicles which may likewise include additional center consoles located between adjacent seat assemblies. The motor vehicle 10 may include additional seating and consoles as is common for a large van, SUV or a bus, for example. It should be appreciated that the vehicle 10 may be a motor vehicle such as a wheeled car, truck, SUV, van or bus, for example, or an airplane, train, boat or other vehicle capable of transporting one or more passengers and cargo items.

The motor vehicle 10 is illustrated configured with the front row of seating having the first seat assembly 16 located on one lateral side (e.g., the left side) of the first row and vehicle rearward of a steering wheel 15 and a dashboard 17 and configured for seating a driver of the vehicle 10. The first seat assembly 16 may include a seat base 16A and a seat back 16B. The second seat assembly 18 is shown positioned vehicle rearward of the dashboard on the opposite lateral side (e.g., right side) of the front row of seating and may likewise have a seat base 18A and a seat back 18B configured for seating a passenger. It should be appreciated that the motor vehicle 10 may be equipped with a plurality of side access doors located proximate to the first row of seating to allow the driver and passengers to enter and exit the cabin interior 12 to access the first and second seat assemblies 16 and 18.

The cabin interior 12 is shown equipped with the front row center console 20 located in the space between the driver first seat assembly 16 and the passenger second seat assembly 18 in the front row of seating. The center console 20 is one example of a vehicle console that may be equipped with a hidden storage compartment that is configured with an RF signal blocker to block the transmission of RF signals as shown and described herein. It should further be appreciated that other configurations of vehicle consoles may include the arrangement of a hidden storage compartment that is configured with an RF signal blocker to block the transmission of RF signals including a rear center console spaced between seats within a second or third row of seating, for example, and may include other consoles located elsewhere on the motor vehicle 10, such as an upper console or glove box located in the dashboard 17, according to other examples.

The vehicle console 20 generally has a housing 22 that is supported on a vehicle floor 14 between the first and second seat assemblies 16 and 18 in the cabin interior 12. It should be appreciated that the housing 22 may be located directly on the underlying vehicle floor 14 or may include one or more intermediate layers such as a base, according to another example. The housing 22 is essentially fixed to the underlying support structure via fasteners such as screws or bolts or may be welded or may otherwise be fixedly connected to the underlying support structure.

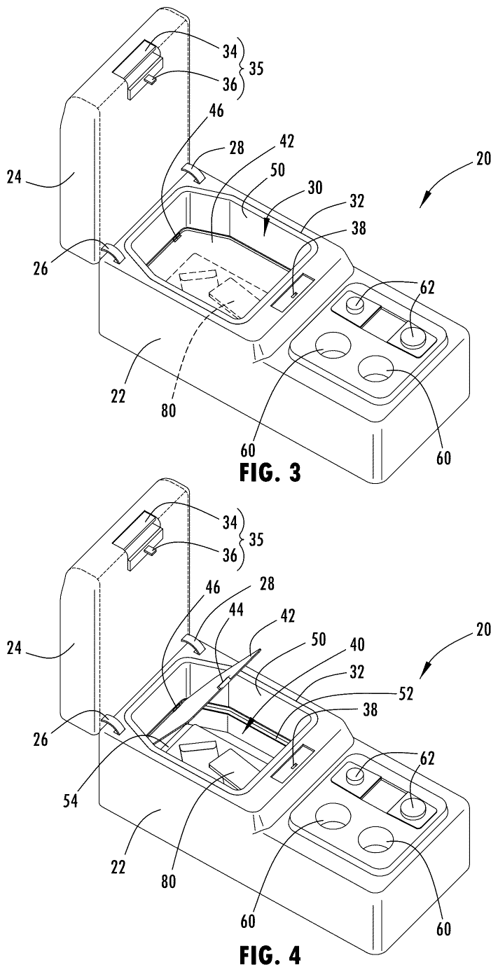

The vehicle console 20 is shown in FIGS. 2 and 3 configured in a generally rectangular configuration having upstanding sidewalls that define a main upper storage compartment 30 having a top access opening 32. The top access opening 32 is further shown partially covered by an armrest lid 24 which serves as a lid to cover the top access opening 32 and also serves as an armrest that may include a cushion for a driver or passenger to rest their arm upon. The armrest lid 24 is connected to a vehicle rearend portion of the housing 22 on top via a pair of hinges 26 and 28. The hinges 26 and 28 may include one or more hinges that allow the armrest lid 24 to rotate between an open vertical position as seen in FIG. 3 exposing the top access opening 32 and a downward closed horizontal cover position that covers the top access opening 32 as shown in FIG. 2. The front end of the armrest lid 24 may further include a latch assembly 35 to latch the armrest lid 24 onto the top of the housing 22 in the closed position. The latch assembly 35 may include a user release mechanism 34 that actuates a latch 36 to unlatch the latch from with a latch retainer 38 on the top of housing 22.

It should be appreciated that the vehicle console 20 may be equipped with other accessories such as a pair of cup holders 60 and vehicle input control devices, e.g., vehicle control knobs, for example. The cup holders 60 and vehicle input control devices 62 are shown located generally forward of the main storage compartment 30 and lid 24. The vehicle console 20 may be otherwise configured to include additional accessories and may be configured in a different shape and size including extending vehicle forward to the dashboard, according to other examples.

Referring to FIGS. 3 and 4, the vehicle console 20 is generally illustrated with the lid 24 connected to a rear end of the housing 22 via first and second hinges 26 and 28 which enable the lid 24 to pivot between the open and closed positions. The lid 24 also includes the latch assembly 35 for latching the lid 24 in the closed position. The latch assembly 35 includes the user release mechanism 34 operatively coupled to the latch 36 located at a front end of the lid 24 and configured to engage the latch retainer 38 which may include a receiver opening on top of the housing 22 when the lid 24 is in the closed position.

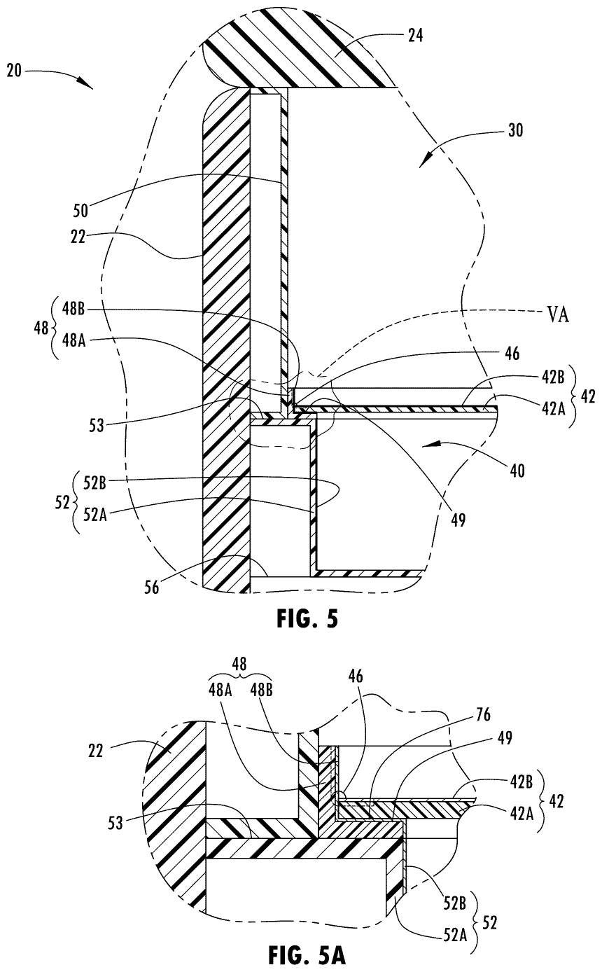

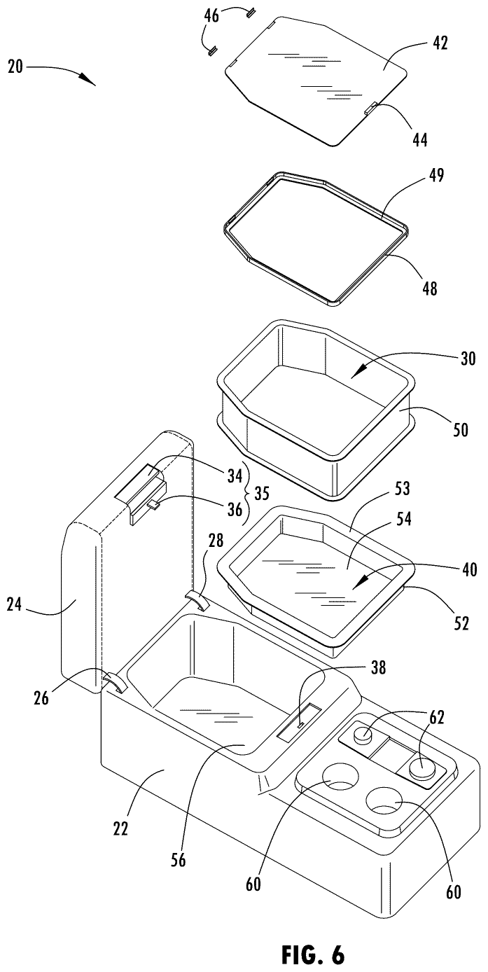

The vehicle console 20 is shown in FIGS. 3-6 having an upper main storage compartment 30 that is accessible from the top access opening 32 when the lid 24 is in the open position as seen in FIG. 3. The upper main storage compartment 30 is generally defined by upper sidewalls 50, the lid 24 on top and an upper panel 42 that serves as a false floor or bottom.

The vehicle console 20 is configured to further include a lower hidden storage compartment 40 located below the upper main storage compartment 30. The lower hidden storage compartment 40 is generally defined by lower sidewalls 52, the upper panel 42 on top and lower floor 54 on the bottom. The lower hidden storage compartment 40 is generally hidden from view from above by employing the hidden upper panel 42 which generally extends across and is supported on top of a rim 53 formed in the upper inner portion of the lower sidewalls 52. The upper panel 42 serves as a floor for the upper storage compartment 30 and a door to access the top of the lower storage compartment 40. The upper panel 42 is further supported on a frame 48 which in turn rests on top of the inner rim 53 formed on the lower side walls 52. The upper panel 42 employs one or more hinges shown as a pair of hinges 46 that hingedly connect the upper panel 42 to the frame 48. The upper panel 42 further has a tab 44 at the end opposite the hinges 46 that allows a user to engage the upper panel 42 and pivot the upper panel 42 upward with force from the closed position shown in FIG. 3 to the open position as seen in FIG. 4. In the open position, the upper panel 42 allows access to the lower hidden storage compartment 40.

The lower hidden storage compartment 40 may include a bottom floor 54 that may rest on or above a floor 56 of the housing 22. It should be appreciated that the floor 56 of housing 22 and the floor 54 of the lower hidden storage compartment 40 may be the same floor. As such, cargo items may be stored within the lower hidden storage compartment 40 and visibly out of sight when the false floor upper panel 42 is in the closed position. In the closed position of the upper cover 42, the upper main storage compartment 30 may store cargo items that may be visible when the lid 24 is in the open position.

The vehicle console 20 is configured having the false floor and hidden storage compartment 40 configured with an RF signal blocker to block RF signals from being transmitted into or out of the lower hidden storage compartment 40 such that RF signal transmissions to or from an electronic device with signal communication circuitry such as a phone, a computer or a tablet, for example, which transmits electromagnetic energy in the form of radio frequency signals. The radio frequency blocker may be configured as an electrically conductive material that forms an electrically conductive shield. The electrically conductive shield may include aluminum, such as a film of aluminum foil that may be lined on or within at least portions of the structure forming the lower hidden storage compartment 40. For example, the electrically conductive shield may include a layer of aluminum foil 42B disposed on or within on a polymeric substrate 42A of the upper hidden panel 42. The layer of aluminum foil 42B may be on the top surface, the bottom surface or disposed within the polymeric substrate 42A. The frame 48 may likewise include a polymeric substrate 48A lined with or otherwise having a layer of aluminum foil 48B. In addition, the lower sidewalls 52 of the lower hidden storage compartment 40 may include a polymeric substrate 52A lined with or otherwise having a layer of aluminum foil 52B. As such, the electrically conductive shield advantageously shields and prevents electromagnetic energy in the form of RF signals from being transmitted into and out of the lower hidden storage compartment 40. It should be appreciated that the bottom floor 54 of the lower hidden storage compartment 40 may likewise include an electrically conductive material such as aluminum foil to shield the bottom portions of the lower hidden storage compartment 40 to block RF signals from being transmitted therethrough.

While the RF signal blocker embodied as a layer of aluminum foil 42B, 48B and 52B forming an electrically conductive shield has been shown and described herein as an aluminum foil, according to one example, it should be appreciated that the electrically conductive shield may be configured with other electrically conductive materials such as, for example, a metal fabric, a conductive plastic, a conductive mesh and other electrically conductive materials that would shield and prevent the transmission of electromagnetic energy such as RF signals from being transmitted through the structure and to or from one or more electronic devices stored in the lower hidden storage compartment 40.

The vehicle console 20 advantageously provides for a lower hidden storage compartment 40 that enables items such as electronic devices and other cargo possessions to be hidden from view. The vehicle console 20 further advantageously prevents the transmission of RF signals to or from electronic devices with communication circuitry that may be stored within the lower hidden storage compartment 40. This may be particularly advantageous in preventing the detection of the existence of electronic devices stored in the lower hidden storage compartment 40 with the external electronic detection devices to prevent unwanted detection of the cargo.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle console comprising:
a housing having an upper storage compartment, a top access opening, and a hidden lower storage compartment;
an upper panel defining a bottom floor of the upper storage compartment;
a lower floor located below the upper panel, wherein the hidden lower storage compartment between the upper panel and the lower floor; and
a radio frequency blocker provided in the upper panel to block the transmission of radio frequency signals through the upper panel.

2. The vehicle console of claim 1, further comprising a lid coupled to the housing and moveable between an open position exposing the top access opening and a closed position covering the top access opening.

3. The vehicle console of claim 1, wherein the upper panel is movable to an open position to allow access to the hidden lower storage compartment.

4. The vehicle console of claim 3, wherein the upper panel is coupled to the housing via one or more hinges.

5. The vehicle console of claim 1, wherein the radio frequency blocker comprises an electrically conductive material.

6. The vehicle console of claim 5, wherein the electrically conductive material is provided in the upper panel.

7. The vehicle console of claim 6, wherein the electrically conductive material is further provided in lower sidewalls of the housing defining the hidden lower storage compartment.

8. The vehicle console of claim 7, wherein the electrically conductive material forms an electrically conductive signal shield.

9. The vehicle console of claim 8, wherein the electrically conductive material comprises aluminum foil.

10. The vehicle console of claim 7, wherein the upper panel is configured to rest on a frame base which rests on a rim on the lower sidewalls.

11. The vehicle console of claim 1, wherein the console is a center console configured to be positioned between first and second seats in a vehicle.

12. A vehicle center console comprising:
a housing having an upper storage compartment, a top access opening, and a hidden lower storage compartment;
an upper panel proximate a bottom of the upper storage compartment and moveable to an open position to access the hidden lower storage compartment;
a lower floor located below the upper panel, wherein the hidden lower storage compartment extends between the upper panel and the lower floor;
a lid coupled to the housing and moveable between an open position exposing the top access opening and a closed position covering the top access opening; and
a radio frequency blocker provided in the upper panel to block the transmission of radio frequency signals through the upper panel.

13. The vehicle center console of claim 12, wherein the upper panel is movable by pivoting to an open position to allow access to the hidden lower storage compartment.

14. The vehicle center console of claim 13, wherein the upper panel is coupled to the housing via one or more hinges.

15. The vehicle center console of claim 12, wherein the radio frequency blocker comprises an electrically conductive material.

16. The vehicle center console of claim 15, wherein the electrically conductive material is provided in the upper panel.

17. The vehicle center console of claim 16, wherein the electrically conductive material is provided in lower sidewalls of the housing defining the hidden lower storage compartment.

18. The vehicle center console of claim 17, wherein the electrically conductive material forms an electrically conductive signal shield.

19. The vehicle center console of claim 17, wherein the upper panel is configured to rest on a frame base which rests on a rim on the lower sidewalls.

20. The vehicle center console of claim 12, wherein the electrically conductive material comprises aluminum foil.
